(19) United States
(12) Patent Application Publication
(10) Pub. No.: US 2003/0043938 A1
(43) Pub. Date: Mar. 6, 2003

(54) Apparatus and method for periodic pattern detection

(75) Inventors: Zeev Masejnik, Netania (IL); Amir Dabby, Sitriya (IL); Yaron Bar, Raanana (IL); Danny Lahav, Kfar Saba (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Optix Networks Inc.

(21) Appl. No.: 10/229,062

(22) Filed: Aug. 28, 2002

Related U.S. Application Data
(60) Provisional application No. 60/315,042, filed on Aug. 28, 2001.

(51) Int. Cl. H04L 27/06

(52) U.S. Cl. 375/340

(57) ABSTRACT

An apparatus and method for detection of periodic patterns in digital high rate transmission systems. The apparatus generates a synthetic data stream and compares, in parallel, a sample of the generated data to a sample of an input data stream. If the number of mismatches between both sets of data is equal to or below a defined threshold, then a detection signal is asserted. The provided apparatus may be configured to detect any type of pattern.

This application claims priority from application No. 60/315,042, filed Aug. 28, 2001, by the same inventors.

References

Patents

U.S. Pat. No. 6,408,034 on June 2002 to Krone, et al.

U.S. Pat. No. 6,389,088 on May 2002 to Blois, et al.

U.S. Pat. No. 6,237,014 on May 2001 to Freidin, et al.

U.S. Pat. No. 6,148,313 on November 2000 to Freidin, et al.

U.S. Pat. No. 6,195,402 on February 2001 to Hiramatsu

U.S. Pat. No. 5,917,852 on June 1999 to Butterfield, et al.

U.S. Pat. No. 5,673,296 on September 1997 to Ohgane

U.S. Pat. No. 5,297,185 on March 1994 to Best, et al.

U.S. Pat. No. 5,528,635 on June 1996 to Negi

U.S. Pat. No. 4,797,951 on January 1989 to Duxbury, et al.

Other References

ITU-T G.709 “Network Node Interface for optical transport network (OTN)” standard (see: http://www.itu.int/ITU-T/).

### FIELD AND BACKGROUND OF THE INVENTION

1. Field of the Invention

The present invention relates to high rate optical networks, and more particularly to pattern detection in data transmitted through such networks.

2. Description of the Related Art

In digital data transmission systems, a sequence of binary information is delivered to a receiver across a transmission channel. Due to interference or impairments in the transmission channel, the binary data may be corrupted or changed while en route to a receiver. Error detection schemes are employed to detect any differences between the originally transmitted data bits and the received data bits. In order to implement an error detection scheme, the bit stream that is transmitted is typically divided into a series of frames, each frame having a known group of bits. The frames can be of fixed or variable length, but in any case, the receiver of the transmission can recover the frame boundaries, and then operate a pattern detection scheme frame by frame.

Pattern detection schemes are commonly used to identify special patterns incorporated in received/transmitted frames. The special patterns are correlated to signals that indicate transmitting/receiving faults, frame synchronization, and signals for controlling and monitoring the transmit/received frame. For example, an optical transport network (OTN) frame may include a generic alarm indication signal (GAIS). The GAIS signal is defined by use of the polynomial X¹¹+X⁹+1, which is also recognized as the PN-11 pattern. There are many different types of patterns known in the art, each specified by a different polynomial.

There are known solutions for periodic pattern detection in digital transmission systems. A common characteristic of these solutions is the use of a serial machine that implements the reverse polynomial that defines a designated pattern. As a result, each machine is configured to detect only a specific type of pattern. The detection is typically executed by applying the reverse polynomial on the input data stream, and counting the number of input and output “one” and “zero” bits throughout a fixed bit interval. If the number of “ones” is below a certain threshold, then a detection signal is yielded. An output “one” bit indicates a mismatch between the preferred pattern and the input data stream. Since the suggested detection machines are serial machines, only a single bit is processed in each cycle. Thus, the detection process is relatively slow and inefficient for transmission systems that have a high transmission rate (e.g. 10 GBPS and above).

Reference is now made to FIG. 1 where an exemplary prior art serial machine 100 for PN-11 pattern detection is shown. Such a method is typical for determining the GAIS when undertaking pattern detection. Machine 100 detects GAIS signals, i.e., PN-11 patterns, from incoming data. The GAIS indicates that a fault has been detected, during the data transmission. The GAIS is part of an OTN frame, which is described in greater detail in ITU-T G.709 standard “Interface for optical transport unit OTN” (http://www-comm.itsi.disa.mil/itu/r₁₃g0700.html). Machine 100 consists of eleven shift registers 110-1 through 110-11 and two exclusive (or XOR) gates 120-1 and 120-2. The number of shift registers is equivalent to the order of a polynomial. Machine 100 runs the reverse polynomial of PN-11. For the GAIS detection, the reverse PN-11 process is applied to the input data stream. In order to detect the PN-11 pattern, machine 100 constantly checks an 8,192-bit interval for the number of output “one” bits. If the number of output “one” bits per interval is less than 256 and the number of input “one” bits per interval is above or equal to 256 in three consecutive intervals, then the GAIS signal is generated. Otherwise, the GAIS is cleared.

The process described above is only efficient for transmission systems with a relatively slow line rate. In order to detect the GAIS, machine 100 must process three times 8,124 bits (i.e. machine 100 determines whether the PN-11 pattern is found only after three cycles each cycle checking 8,124 bits serially). Hence, serial machines, such as machine 100 cannot be used to detect patterns in systems with relatively high line rate (over 10 GBPS), as this would have a significant adverse effects on the system's performance.

Typical methods for detecting patterns in input data suggest usage of a serial machine for pattern detection. Usage of a serial machine, however, is intrinsically limited in its ability to enable detection in high-speed networks.

There is thus a widely recognized need for, and it would be highly advantageous to have, an apparatus that efficiently detects patterns in input data streams that are transmitted in high line rates. It would be further advantageous if the detecting apparatus would detect any type of pattern, not being limited to patterns defined by the polynomial PN-11 (i.e., X¹¹+X⁹+1) and PN-9 (i.e., X⁹+X⁵+1), or other similar patters defined in data streams transmitted through optical networks.

### SUMMARY OF THE INVENTION

According to the present invention there is provided a system and method for detection of periodic patterns in digital high rate transmission systems. The present invention suggests a parallel machine that enables acceleration of the detection process, thereby being effective for detection in high rate systems. In particular, the present invention can be used to generate a synthetic data stream and compare, in parallel, a sample of the generated data to a sample of an input data stream. If the number of mismatches between both sets of data is equal to or below a defined threshold, then a detection signal is asserted. The provided apparatus may be configured to detect any type of pattern.

According to a preferred embodiment of the present invention, a periodic pattern detection machine (PPDM) is provided. The PPDM consists of a stream generator, at least two comparators, as well as control unit. The stream generator generates a synthetic data stream, which is subsequently compared with bits from the input data stream, by means of the first comparator. If the comparison indicates equality, then in the subsequent cycles, the stream generator generates a new sequence of bits in each cycle, using bits of the preceding generated bits sequence. If the comparison yields a mismatch, then the stream generator generates a new sequence of bits. The stream generator produces a synthetic stream, which is an errorless data stream that is equivalent to the input data stream. A second (bit-wise) comparator subsequently compares between a sample of bits from the generated data bits from the input data stream. This second comparator performs bit-to-bit comparison, such that if at least one mismatch was detected, then PPDM outputs an error signal. On the other hand, if the bit-wise comparator finds that both sets of bits are equal, then the process continues with the next frame. If throughout a determined number of consecutive frames the bit-map comparator finds no mismatches, then PPDM generates a detection signal. An error signal is configured to restart the detection process. The control unit manages the production of the error signals and the detection signal.

According to an additional embodiment of the present invention, the PPDM also includes an additional comparator and an accumulator, for enabling the PPDM to compare between a number of generated bits and a number of input data bits in parallel, according to a determined error threshold.

A person skilled in the art would easily note that the various bit stream parameters and the error threshold could easily be configured to enable PPDM to detect any type of pattern.

### BRIEF DESCRIPTION OF THE DRAWINGS

The principles and operation of a system and a method according to the present invention may be better understood with reference to the drawings, and the following description, it being understood that these drawings are given for illustrative purposes only and are not meant to be limiting, wherein:

FIG. 1—is an illustration of a serial pattern detection machine.

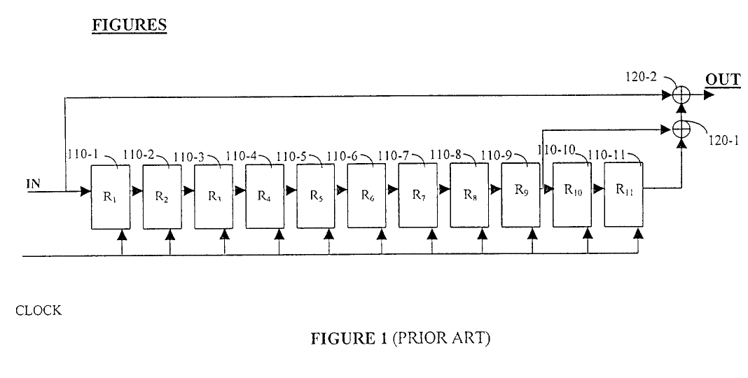

FIG. 2—is a block diagram of the provided apparatus in accordance with one embodiment of the invention.

FIG. 3—is an exemplary flow chart describing the detection process in accordance with one embodiment of the present invention.

FIG. 4—is a non-limiting example for the detection process.

FIG. 5—is a block diagram of an alternative apparatus in accordance with one embodiment of the invention.

FIG. 6—is an exemplary flow chart describing the detection process in accordance with one embodiment of the present invention.

FIG. 7—is a non-limiting example for the detection process.

### DESCRIPTION OF THE PREFERRED EMBODIMENT

The present invention relates to a system and method for detection of periodic patterns in digital high rate transmission systems. Such high rate transmission systems include optical networks, such as synchronous optical network (SONET), synchronous digital hierarchy (SDH) network, and optical transport network (OTN).

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention can be used to generate a synthetic data stream and compare, in parallel, a sample of the generated data to a sample of an input data stream. If the number of mismatches between both sets of data is equal to or below a defined threshold, then a detection signal is asserted. The provided apparatus may be configured to detect any type of pattern.

The principles and operation of a system and a method according to the present invention may be better understood with reference to the drawings and the accompanying description, it being understood that these drawings are given for illustrative purposes only and are not meant to be limiting, wherein:

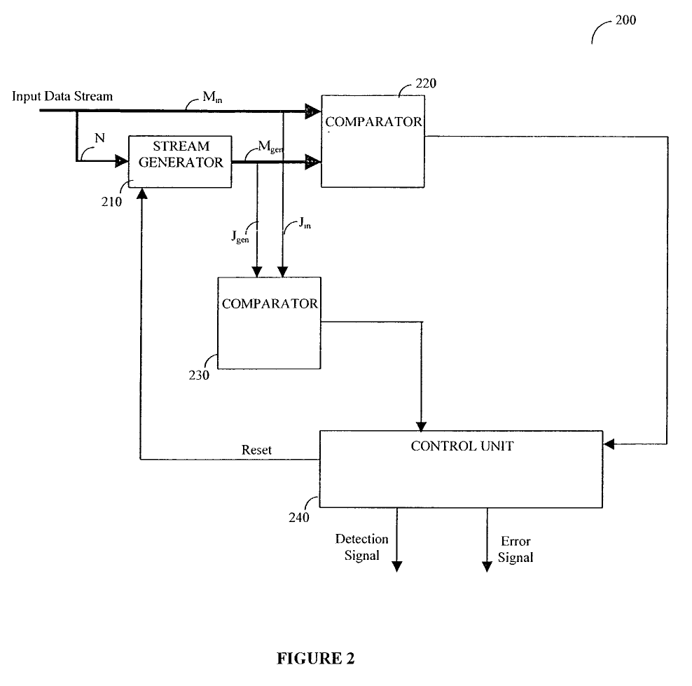

Reference is now made to FIG. 2 where an exemplary block diagram of periodic pattern detection machine (PPDM) 200, operating in accordance with one embodiment of the disclosed invention, is shown. PPDM 200 detects patterns in incoming data streams by comparing once, in each frame, between “J” generated bits and “J” input bits, as indicated in FIG. 2. PPDM 200 consists of stream generator 210, comparators 220 and 230, as well as control unit 240. Stream generator 210 generates a pseudo-random bit sequence based on a given polynomial of order N. A detailed explanation of stream generator 210 is provided in U.S. patent application Ser. No. 09/904,277, entitled “Method and Machine for Scrambling Parallel Data”, by Arye Peyser el al., assigned to common assignee and which is hereby incorporated by reference for all that it discloses.

Stream generator 210 generates a synthetic data stream that consists of M bits derived from N bits in the incoming data stream, where N is significantly smaller than M (N<<M). First, stream generator 210 generates M bits by using N bits from the input data stream. The “N” bits are the last “N” bits of the “M” input bits (hereinafter “Mᵢₙ”). The generated M bits (hereinafter “M_{gen}”) are then compared with the inputted M bits (Mᵢₙ) from the input data stream, by means of comparator 220. If the comparison indicates equality, then in the subsequent cycles, stream generator 210 generates another M_{gen} bit stream in each cycle, using N bits of the preceding M_{gen} bit stream. In this way, the series of generated bit streams are errorless. If the comparison by comparator 220 yields a mismatch, then stream generator 210 generates a new sequence of M_{gen} bit stream, using N bits from the input M stream. Stream generator 210 produces a synthetic stream, which is an errorless data stream that is equivalent to the input data stream. The aim of the stream generator is to generate an errorless stream for the purpose of the pattern detection. For this purpose, the stream generator first produces M bits derived from N bits from the input data stream (Mᵢₙ). Next, the generated stream is compared with the input data stream (to see whether M_{gen}=Mᵢₙ). If M_{gen} equals Mᵢₙ, then the stream generator is considered to be synchronized. From this stage, in each cycle, the stream generator generates a new M bits sequence (M_{gen}) derived from N bits of the previous generated (M_{gen}). It should be noted that M_{gen} is correlated to Mᵢₙ in the first cycle only. In the subsequent cycles, stream generator generates a data stream (M_{gen}) that is not correlated to Mᵢₙ, and therefore Mᵢₙ may include errors.

Comparator 230 subsequently compares between a sample of “J” bits from the generated data and “J” bits from the input data stream, where J is significantly smaller than M (J<<M). Comparator 230 is a bit-wise comparator that performs bit-to-bit comparison. If at least one mismatch was detected, then PPDM 200 outputs an error signal. An error signal is configured to restart the detection process. On the other hand, if comparator 230 finds that both sets of bits are equal, then the process continues with the next frame. If throughout “T” consecutive frames comparator 230 finds no mismatches, PPDM 200 generates a detection signal. Control unit 240 manages the production of the error signals and the detection signal, by counting the number of consecutive frames, by means of a counter, which indicates the number of consecutive frame, i.e. the value of “T”. A person skilled in the art would easily note that the parameters “M”, “J”, “N” and “T” are variables that could easily be configured to enable PPDM 200 to detect any type of pattern. The synthetic data stream corresponds to an anticipated data stream, is errorless, and comprises generating a constant number of bits (which is a configurable parameter). PPDM 200 thereby detects any type of pattern, not being limited to patterns defined by the polynomial PN-11 (i.e., X¹¹+X⁹+1) and PN-9 (i.e., X⁹+X⁵+1), or other similar patters defined in data streams transmitted through optical networks.

Following is an example showing an exemplary and non-limiting way for detecting a PN-11 pattern using PPDM 200. In each cycle, stream generator 210 generates 128 bits (i.e. M=128) derived from eleven bits (i.e. N=11) from the input data stream, or from the preceding M generated bits, as the case may be. Eight bits (i.e. J=8) from the generated data are sampled and compared with eight bits from the input data stream. If the comparison results in an inequality, then the error signal is generated. On the other hand, if there are only matches during a determined number of consecutive frames (for example, 3 frames), the detection (i.e. GAIS) signal is generated. In this example, it takes 1,024 cycles to process a single frame. It can be noticed that only 3,072 cycles are required to detect the PN-11 pattern, as opposed to the prior art approach where three times 8,192 (24,576) cycles are required.

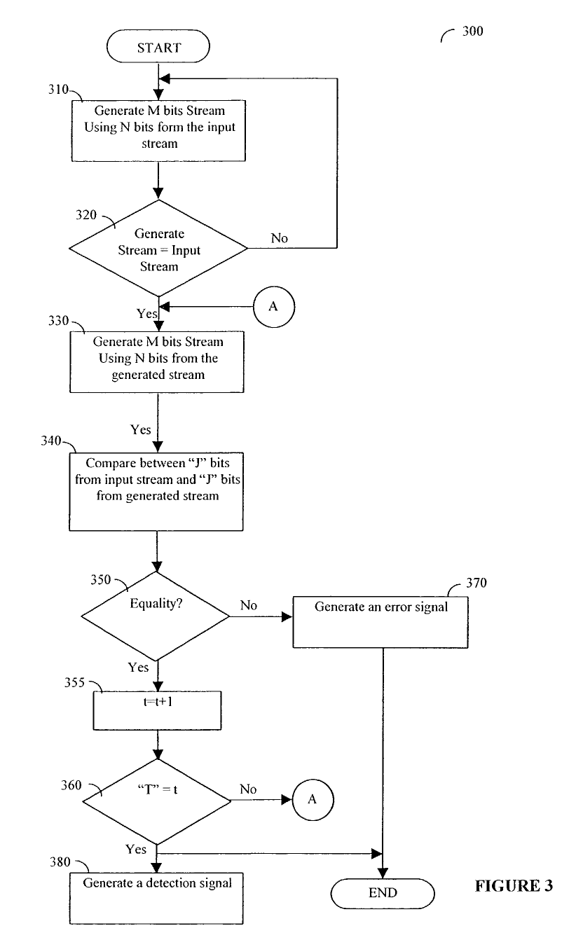

Reference is now made to FIG. 3 where an exemplary flow chart 300 describing the method for patterns detection, in accordance with the functionality of PPDM 200 is shown. At step 310, M bits are generated (hereinafter “Mgen”) by means of stream generator 210, using N bits from the input data stream, where the N bits are always the last “N” bits of the input “M” bits (hereinafter “Min”). At step 320, the Mgen bits are compared with Min bits. If the comparison indicates a mismatch (denoting that the stream generator is unsynchronized), then process continues at step 310, by generating a new Mgen bit stream by means of stream generator 210 that generates a new bit sequence. If the comparison yields a match, stream generator 210 is considered to be synchronized and the detection process continues at step 330. At step 330, stream generator 210 generates a new Mgen bit stream using the N last bits derived from the preceding Mgen. For each frame a new sequence of Mgen bits is generated. At step 340, a sample of “J” bits from the generated data (hereinafter “Jgen”) is compared with “J” bits from the input data stream (hereinafter “Jin”), by means of comparator 230. The actual pattern detection process is therefore performed by comparator 230, on the basis of an errorless stream from stream generator 210. At step 350, it is determined whether the comparison at step 340 uncovered any mismatches. If in step 340 mismatches are found, then, at step 370, the error signal is generated; otherwise the detection process continues at step 355. At step 355, a counter, which is part of control unit 350, counts the number of frames (“t”) corresponding to matches. At step 360, it is determined whether “t” equals “T”, where “T” is the number of consecutive frames without mismatches. If it is determined at step 380 that “t” equals “T”, the detection signal is generated. If it is determined at step 380 that “t” does not equal “T”, the process returns to step 330 (as indicated by the two “A” circles in FIG. 3, indicating the jump from step 360 back to step 330). It should be noted that in each frame the “J” bits are sampled from the same position in the frame, thereby simplifying the required logic.

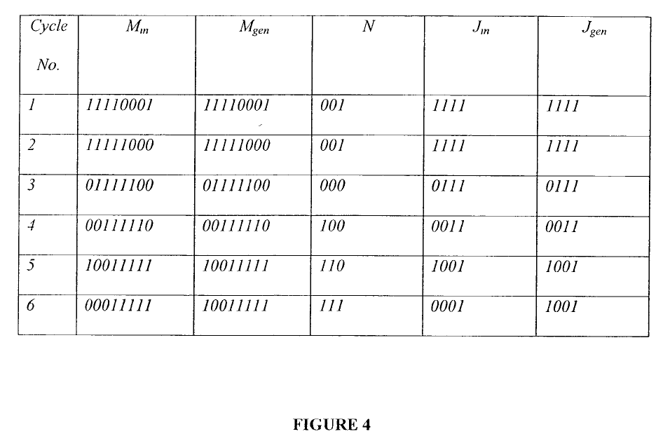

Reference is now made to FIG. 4, which shows a non-limiting example for the detection process, as described in FIG. 3. The following parameters are used: M=16 bits, J=4 bits, N=3 bits T=1(frame), and the frame length is 256 bits. FIG. 4 shows the values of Min, Mgen, N, Jin and Jgen, in each cycle. In the first cycle, Mgen is generated using the last three bits of Min, i.e., using bit stream “001”. Subsequently, Mgen is compared with Min. Since both sets of bits are equal, the following cycles require a new set of Mgen to be generated using the last “N” bits of the preceding Mgen. The different values of Mgen result from the equations used for generating the pseudo-random stream. Jgen and Jin are the four most significant bits of Mgen and Min respectively. It can be noticed that in cycle 6, Jin is not equal to Jgen , hence an error signal is generated and the detection process is restarted.

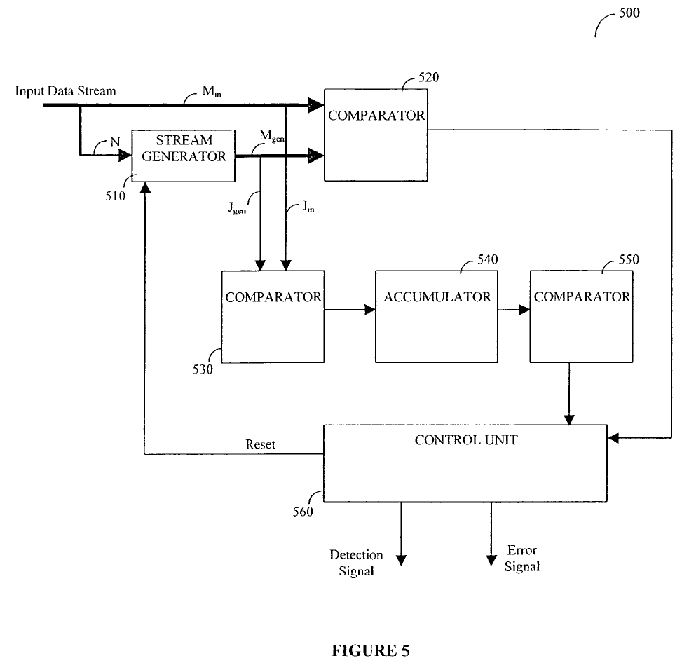

Reference is now made to FIG. 5 where an exemplary block diagram of a periodic pattern detection machine (PPDM) 500, operating in accordance with an additional embodiment of the present invention, is shown. This embodiment enables pattern detection in a high-speed network, by comparing between a number of generated bits and a number of input data bits in parallel, according to a determined error threshold. According to the present embodiment, comparison between a plurality of bits in each cycle can be executed simultaneously. Accordingly, in each cycle PPDM 500 compares between a number of generated bits and a number of input data bits, in parallel. Subsequently, the number of mismatches is compared with an error threshold. If the number of mismatches does not exceed the error threshold, through a fixed number of frames, a detection signal is generated. PPDM 500 simultaneously compares between a plurality of bits in each cycle. Hence, it reduces the time required for detection, thus enabling the detection of patterns transmitted at high data rates. As can be seen in the figure, PPDM 500 consists of stream generator 510, three comparators 520, 530, and 550, accumulator 540, and control unit 560. Stream generator 510 generates a pseudo-random bit sequence based on a given polynomial of order N. A detailed explanation of stream generator 510 is provided in U.S. patent application Ser. No. 09/904,277, entitled “Method and Machine for Scrambling Parallel Data”, by Arye Peyser el al., assigned to common assignee and which is hereby incorporated by reference for all that it discloses.

For each cycle, stream generator 510 generates M (hereinafter “M_{gen}”) bits derived from N bits, where N is much smaller than M. The “N” bits are the last “N” bits of the “M” input bits (hereinafter “Mᵢₙ”). First, stream generator 510 generates the M_{gen} bit stream, derived from the N bits of the input data stream. The M_{gen} bit stream is compared with the Mᵢₙ bit stream, by means of comparator 520. If the comparison indicates equality, then in the subsequent cycles, stream generator 510 generates another bit sequence of M_{gen}. This time, M_{gen} bits are derived from N bits taken from the preceding M_{gen}. If a mismatch is found, then stream generator 510 generates a new bits sequence of M_{gen}. Stream generator 510 produces a synthetic stream, which is an errorless data stream that is equivalent to the input data stream.

Comparator 530 compares between a sample of “J” bits from the generated data and “J” bits from the input data stream. Comparator 530 is a bit-wise comparator, for performing bit-to-bit comparisons. The mismatches detected by comparator 530 are aggregated by means of accumulator 540. Accumulator 540 outputs the number of mismatches detected in a single frame. Comparator 550 compares the number of mismatches, provided by accumulator 540, to an error threshold. The error threshold defines the number of permitted mismatches in a single frame. If the number of mismatches exceeds the error threshold, then an error signal is generated, which subsequently restarts the detection process. Conversely, a detection signal is generated if the number of mismatches in “T” consecutive frames is below the error threshold. “T” is an integer greater than or equal to one. Control unit 560 manages the production of the error signals and the detection signals. It should be noted that the parameters “M”, “J”, “N”, “T”, and the error threshold, could easily be configured to enable PPDM 500 to detect any type of pattern.

Following is an example showing a non-limiting way for the detection of a PN-11 pattern using PPDM 500. In each cycle, stream generator 510 generates 128 bits (i.e. M=128) derived from eleven bits (i.e. N=11) from the input data stream, or from the preceding M generated bits, as the case may be. Eight bits (i.e. J=8) from the generated data are sampled and compared with eight bits from the input data stream. J is equal to eight in order to process the required bits interval (i.e., 8192) through a single frame. The mismatches found during the comparison are aggregated by means of accumulator 540. If during a single frame there are more than 256 mismatches, then the error signal is generated. On the other hand, if during three consecutive frames, in each frame, there are less than 256 mismatches, the detection (i.e. GAIS) signal is yielded. The above example requires 1,024 cycles to process a single frame, and therefore requires only three times 1024 (3,072) cycles to detect the PN-11 pattern. This is contrasted with the prior art, wherein three times 8192 (24,576) cycles are required.

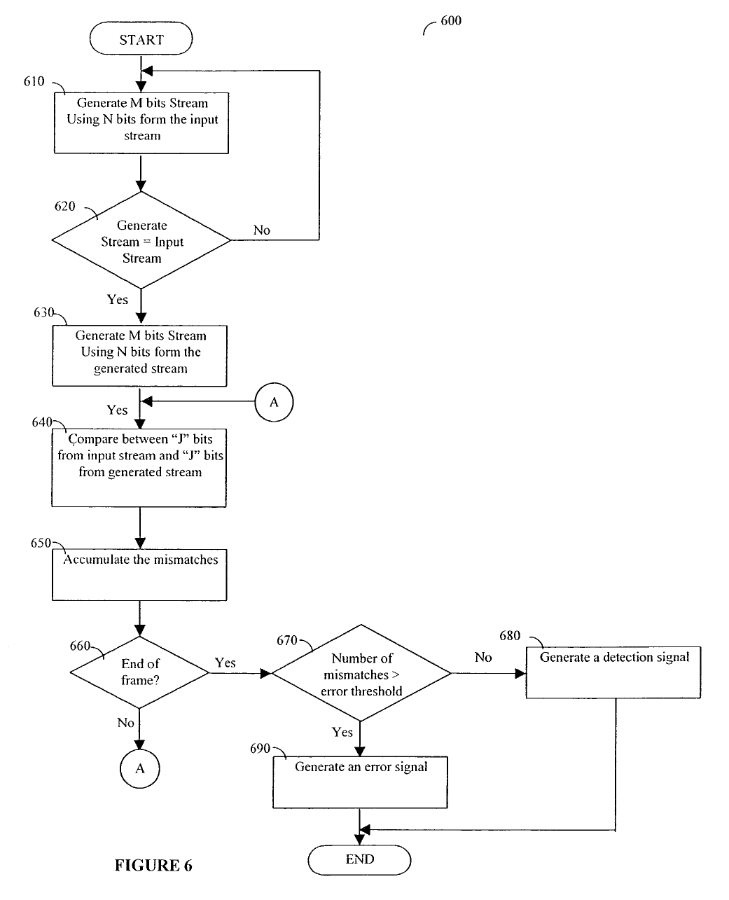

Reference is now made to FIG. 6 where an exemplary flow chart 600 describing the method for pattern detection, in accordance with the functionality of PPDM 500 is shown. At step 610, a bit sequence of M_{gen} bits stream is generated, using the last N bits of the M bits from the input data stream (hereinafter Mᵢₙ). At step 620, M_{gen} is compared with Mᵢₙ. If the comparison indicates inequality, then stream generator 510 generates a new bits sequence of M_{gen} using N bits from Mᵢₙ. Otherwise, stream generator 510 is considered to be synchronized and the detection process continues at step 630. At step 630, stream generator 510 generates another bits stream of M_{gen} using N bits derived from the preceding M_{gen}. For each cycle, a new bits sequence of M_{gen} is generated. At step 640, a sample of “J” bits from M_{gen} is compared with “J” bits from Mᵢₙ, by means of comparator 530. Comparator 530 performs bit-to-bit matching. For example, if a sample of the generated data is “10001”, and the sample of the input data stream is “11111”, there are three mismatches. At step 650, the mismatches found at step 640 are accumulated, by means of accumulator 540. Accumulator 540 accumulates all the mismatches that appear in a single frame. At step 660, a check is performed to find if the detection of the entire frame has been completed. If so, the detection process continues at step 670, or if the entire frame has not been completed, at step 630. At step 670, it is determined whether the number of mismatches per frame exceeds the error threshold. If the number of mismatches per frame exceeds the error threshold, an error signal is generated at step 690. Otherwise, a detection signal is generated at step 680. It should be noted that in some cases PPDM 500 may be configured to output the detection signal only if the error signal was not asserted during “T” consecutive frames.

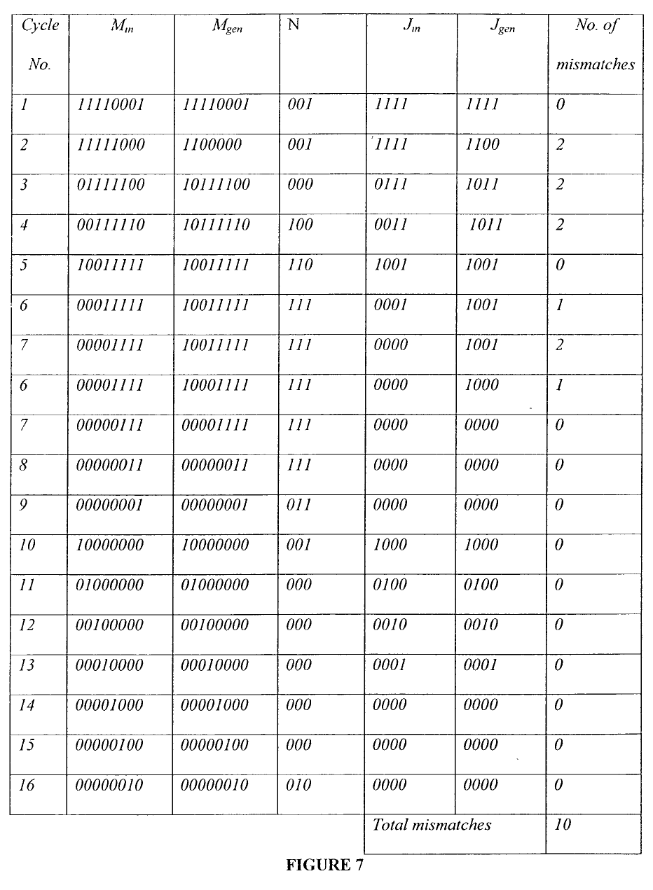

Reference is now made to FIG. 7, which shows a non-limiting example of the detection process, described in FIG. 5. The following parameters are used: M=16 bits, J=4 bits, N=3 bits, T=1 frame, and the frame length is 256 bits. For the purpose of this example, the error threshold is equal to 32 mismatches. FIG. 7 shows the value of Mᵢₙ, M_{gen}, N, Jᵢₙ and J_{gen}, and the number of mismatches, in each cycle. In the first cycle, a bit sequence of M_{gen} is generated using the last three bits of Mᵢₙ, i.e., using bits “001”. Subsequently, M_{gen} is compared with Mᵢₙ, and since both sequences are equal, in the following cycle a new sequence of M_{gen} is generated using the last “N” bits of the preceding M_{gen}. The different values of M_{gen} result from the equations used for generating the pseudo-random stream. J_{gen} and Jᵢₙ are the four most significant bits (MSB) of M_{gen} and Mᵢₙ respectively. It can be seen that the number of mismatches found during this frame is equal to ten (10) and hence a detection signal is generated. The detection signal is generated in this case, since the input data stream (i.e. Mᵢₙ) matches the generated data (i.e., M_{gen}), within the permitted error level.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. A periodic pattern detection machine (PPDM) capable of detecting patterns in an input data stream transmitted through a high-rate network, said PPDM comprising:
i. a stream generator capable of generating a synthetic data stream;
ii. a first comparator capable of comparing said synthetic data stream and the input data stream;
iii. a second comparator capable of performing parallel comparisons between bits from said synthetic data stream and bits from said input data stream; and
iv. a control unit capable of outputting a detection signal and an error signal based on results of said comparisons.

2. The PPDM of claim 1, wherein said synthetic data stream is based on a predefined polynomial.

3. The PPDM of claim 2, wherein said synthetic data stream is selected from the group consisting of PN-11 and PN-9.

4. The PPDM of claim 3, wherein said PN-11 is the polynomial X¹¹+X⁹+1.

5. The PPDM of claim 3, wherein said PN-9 is the polynomial X⁹+X⁵+1.

6. The PPDM of claim 1, wherein said high-rate network is an optical network.

7. The PPDM of claim 6, wherein said optical network is at least one network selected from the group consisting of: synchronous optical network (SONET), synchronous digital hierarchy (SDH) network and optical transport network (OTN).

8. The PPDM of claim 1, wherein said synthetic data stream corresponds to at least an anticipated pattern.

9. The PPDM of claim 1, wherein said synthetic data stream is errorless.

10. The PPDM of claim 1, wherein said generation of said synthetic data stream comprises generating a constant number of bits.

11. The PPDM of claim 10, wherein said constant number of generated bits is a configurable parameter.

12. The PPDM of claim 1, wherein comparing between said generated synthetic data stream and input data stream is performed to determine whether said synthetic data stream is synchronized with said input data stream.

13. The PPDM of claim 1, wherein said second comparator is a bit-wise comparator.

14. The PPDM of claim 1, wherein said error signal is generated if said second comparator indicates inequality.

15. The PPDM of claim 1, wherein said detection signal is generated if said second comparator detects equality.

16. The PPDM of claim 15, wherein said detection signal is generated after a determined number of consecutive frames each showed equality.

17. The PPDM of claim 16, wherein said number of frames is a configurable parameter.

18. The PPDM of claim 16, wherein said frame is selected from the group consisting of a fixed length of bits interval and variable length of bits interval.

19. The PPDM of claim 1, wherein said control unit is further capable of resetting said stream generator.

20. The PPDM of claim 1, wherein said stream generator, said first comparator, and said second comparator are configured to detect any type of pattern.

21. A method for detecting patterns in an input data stream transmitted through a high-rate network using a periodic pattern detection machine (PPDM), said method comprising the steps of:
i) generating “M” bits of data stream derived from “N” bits, said “N” bits are the last “N” bits of an “M” bit input data stream;
ii) comparing between said “M” generated bits and said “M” bit input data stream, by means of a first comparator;
iii) if said comparison indicates inequality then repeating said steps i) and ii) otherwise continuing with step iv);
iv) generating “M” bits of data stream derived from “N” bits, said “N” bits are the last “N” bits of said preceding “M” generated bits;
v) comparing in parallel between “J” designated bits sampled from said “M” generated bits and “J” bits sampled from said “M” bit input data stream, by means of a bit-wise comparator;
vi) if said comparison indicates inequality then generating an error signal, by means of a control unit; and
vii) if said comparison indicates equality then generating a detection signal, by means of said control unit.

22. The method of claim 21, wherein said detection signal is generated after a number of consecutive frames each showed equality.

23. The method of claim 22, wherein said frames are selected from the group consisting of a fixed length of bits interval and variable length of bits interval.

24. The method of claim 22, wherein said number of consecutive frames is a configurable parameter.

25. The method of claim 21, wherein said patterns are at least selected from the group consisting of PN-11 and PN-9.

26. The method of claim 25, wherein said PN-11 is the polynomial X¹¹+X⁹+1.

27. The method of claim 25, wherein said PN-9 is the polynomial X⁹+X⁵+1.

28. The method of claim 21, wherein said “M”, said “N”, and said “J” are configurable parameters.

29. The method of claim 21, wherein said stream generator, said first comparator, and said bit-wise comparator are configured to detect any type of pattern.

30. A periodic pattern detection machine (PPDM) capable of detecting patterns in an input data stream transmitted through a high-rate network, by enabling an error scale, said PPDM comprising at least:
i. a stream generator capable of a generating synthetic data stream;
ii. a first comparator capable of comparing said synthetic data stream and the input data stream;
iii. a second comparator capable of performing parallel comparisons between bits from said synthetic data stream and bits from said input data stream;
iv. an accumulator capable of accumulating mismatches detected by means of said second comparator;
v. a third comparator capable of comparing between said mismatches based on an error threshold; and
vi. a control unit capable of outputting a detection signal and an error signal base on results of said comparisons.

31. The PPDM of claim 30, wherein said synthetic data stream is based on a predefined polynomial.

32. The PPDM of claim 31, wherein said patterns are selected from the group consisting of PN-11 and PN-9.

33. The PPDM of claim 32, wherein said PN-11 is the polynomial X¹¹+X⁹+1.

34. The PPDM of claim 32, wherein said PN-9 is the polynomial X⁹+X⁵+1.

35. The PPDM of claim 30, wherein said high-rate network is an optical network.

36. The PPDM of claim 35, wherein said optical network is at least one selected from the group consisting of synchronous optical network (SONET), synchronous digital hierarchy (SDH) network, optical transport network (OTN).

37. The PPDM of claim 30, wherein said synthetic data stream corresponds to at least an anticipated pattern.

38. The PPDM of claim 30, wherein said synthetic data stream is errorless.

39. The PPDM of claim 30, wherein generation of said synthetic data stream comprises generating a constant number of bits in each cycle.

40. The PPDM of claim 39, wherein said number of generated bits is a configurable parameter.

41. The PPDM of claim 30, wherein said second comparator is a bit-wise comparator.

42. The PPDM of claim 30, wherein said error signal is generated if said number of mismatches exceeds said error threshold.

43. The PPDM of claim 30, wherein said detection signal is generated if said number of mismatches is below said error threshold for a number of consecutive frames.

44. The PPDM of claim 43, wherein said frame is selected from the group consisting of a fixed length of bits interval and variable length of bits interval.

45. The PPDM of claim 43, wherein said number of frames is a configurable parameter.

46. The PPDM of claim 30, wherein said control unit is further capable of resetting said stream generator.

47. The PPDM of claim 30, wherein accumulating said mismatches is performed in a single frame.

48. The PPDM of claim 30, wherein said error threshold is determined according to a number of permitted mismatches per a single frame.

49. A method for fast patterns detecting using a PPDM comprising of a stream generator, a first comparator, a second comparator, a third comparator, an accumulator, and a control unit, said method comprising the steps of:
i. generating “M” bits of data stream derived from “N” bits, said “N” bits are the last “N” bits of an “M” bit input data stream;
ii. comparing between said “M” generated bits and said “M” bit input data stream, by means of said first comparator;
iii. if said comparison indicates inequality then repeating steps i) and ii) or otherwise continuing with step iv);
iv. generating “M” bits of data stream derived from “N” bits, said “N” bits are the last “N” bits of said preceding “M” generated bits;
v. comparing in parallel between “J” designated bits sampled from said “M” generated bits and “J” bits sampled from said “M” bit input data stream, by means of said second comparator;
vi. accumulating the mismatches uncovered in said step v), by means of said accumulator;
vii. comparing between number of mismatches calculated in said step v) and an error threshold, by means of said third comparator;
viii) generating at least one of a detection signal and an error signal based on results step vii).

51. The method of claim 50, wherein said “M”, said “N”, and said “J” are configurable parameters.

52. The method of claim 50, wherein said patterns are based on a predefined polynomial.

53. The method of claim 50, wherein said patterns are at least one of: PN-11, PN-9.

54. The method of claim 53, wherein said PN-11 is the polynomial X¹¹+X⁹+1.

55. The method of claim 53, wherein said PN-9 is the polynomial X⁹+X⁵+1.

56. The method of claim 50, wherein generation of said “M” bit data stream is performed by means of said stream generator.

57. The method of claim 50, wherein said step v) further comprises performing a bit-wise comparison.

58. The method of claim 50, wherein said step v) comprises accumulating said mismatches uncovered in a single frame.

59. The method of claim 50, wherein said error threshold is the number of permitted mismatches per a single frame.

60. The method of claim 50, wherein said error signal is generated if said number of mismatches exceeds said error threshold.

61. The method of claim 50, wherein said detection signal is generated if said number of mismatches is below said error threshold through a number of consecutive frames.

62. The method of claim 61, wherein said number of frames is a configurable parameter.

63. The method of claim 61, wherein said frame is one of a fixed length of bits interval and variable length of bits interval.
